(19) United States
(12) Patent Application Publication
(10) Pub. No.: US 2007/0126299 A1
(43) Pub. Date: Jun. 7, 2007

(54) Constrained layer metallic endcap for motor

(75) Inventor: Paul Stephen McLennan, London (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Inc., London (CA)

(21) Appl. No.: 11/604,709

(22) Filed: Nov. 28, 2006

Related U.S. Application Data
(60) Provisional application No. 60/742,063, filed on Dec. 2, 2005.

(51) Int. Cl. H02K 5/00; H02K 5/16

(52) U.S. Cl. 310/89; 310/90

(57) ABSTRACT

An endcap 26 for a motor 28 includes a first layer 32 of metal material, a second layer 32′ of metal material, and a third layer 30 of thermal isolating material constrained between the first and second layers such that the third layer inhibits the transfer of thermal energy from the first layer to the second layer and from the second layer to the first layer. The endcap 26 combines the functions of an endplate and heat shield into a single component for isolating internal motor components from radiant energy sources.

This application claims the benefit of the earlier filing date of U.S. Provisional Application No. 60/742,063, filed on Dec. 2, 2005, which is incorporated by reference herein in its entirety.

### FIELD OF THE INVENTION

This invention relates to motors for automotive applications such as, but is not limited to, engine cooling, HVAC (Heating, Ventilation and Air Conditioning) and, more particular, to an endcap or endplate for an electric motor formed from a constrained layer material which forms a thermal barrier to isolate internal motor components from radiant energy sources.

### BACKGROUND OF THE INVENTION

A cooling fan motor for a vehicle, which is normally attached to the downstream side of a heat exchanger core, is typically packaged in close proximity to various under hood engine components. Restricted packaging space forces powertrain engineers to create engine orientations which are transversely mounted. Engine layouts of this type generally place the rear endcap of the electric cooling fan motor near the exhaust manifold of the engine. Severe operating duty of the engine (i.e. trailer tow, hill climbing, high speed etc.) can generate high under hood ambient air temperatures as well as expose the electric motor to high radiant energy levels. As shown in FIG. 1, the radiant energy from the engine is absorbed by the metal endcap 12 of the electric motor 10 and thermally conducted to internal motor components such as the bearings and bushings 14. The illustrated conventional motor of FIG. 1 includes a shaft 16, a commutator 18, a brush card 20, oil reservoir 21, an armature core 22, generally indicated at 22, and a bushing retainer 23.

Electric engine cooling motors have typically been protected from radiant energy sources in the past using the following three basic methods.

1) A separate metal heat shield attached to the rear of the fan module. As shown in FIG. 2, the heat shield 24 normally consists of a thin gauge steel or aluminum sheet stamped into a shape which can be joined to the motor endcap 12 or mounted separately to the plastic fan shroud which supports the motor. A sizeable gap G between the heat shield and motor endcap typically exists for thermal or packaging reasons.

2) A second method of thermal protection is to bond a flexible metallic foil covering onto a woven fiberglass backing. A high temperature pressure sensitive adhesive is applied to the opposite face so that the cover can be adhered to the plastic fan shroud which supports the cooling fan motor. This type of shielding is easily cut into various shapes and is flexible enough to conform to unique shroud geometries.

3) Another solution to limit the thermal exposure of the motor is to cover the exhaust manifold or other heat source itself with a shield. This in effect, protects the cooling fan motor by reflecting the energy at its source.

These prior systems have several disadvantages. The addition of a separate component (heat shield) results in an increased cost. The value of the metal stamping, the assembly costs, logistics costs, tooling, overhead, inventory, packaging and fasteners must all be considered. A heat shield also increases the overall axial length of the module assembly. A longer axial length may also prevent the cooling fan module from meeting packaging requirements. The increased part count due to the shield and fasteners generally reduces reliability of the overall assembly due to higher complexity. The addition of a heat shield may restrict airflow movement through the motor which can prevent proper cooling of internal components thus leading to reduced life or premature failure. The large surface area and thin gauge material used in construction of a heat shield can lead to increased structure born noise if not carefully engineered.

There is a need to provide a constrained layer material endcap that combines the functions of an endplate and heat shield into a single component for isolating internal motor components from radiant energy sources.

### SUMMARY OF THE INVENTION

An object of the present invention is to fulfill the need referred to above. In accordance with the principles of the present invention, this objective is obtained by providing an endcap for a motor. The endcap includes a first layer of metal material, a second layer of metal material, and a third layer of thermal isolating material constrained between the first and second layers such that the third layer inhibits the transfer of thermal energy from the first layer to the second layer and from the second layer to the first layer.

In accordance with another aspect of the invention, a heat shield member for shielding a component in an engine compartment of a vehicle is provided. The member includes a first layer of metal material, a second layer of metal material, and a third layer of thermal isolating material constrained between the first and second layers such that the third layer inhibits the transfer of thermal energy and vibration from the first layer to the second layer and from the second layer to the first layer. The member can be an endcap of a motor or a thermal shield for as alternators, electric water pumps, starter motors, etc.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a sectional view of motor having a conventional metal endcap.

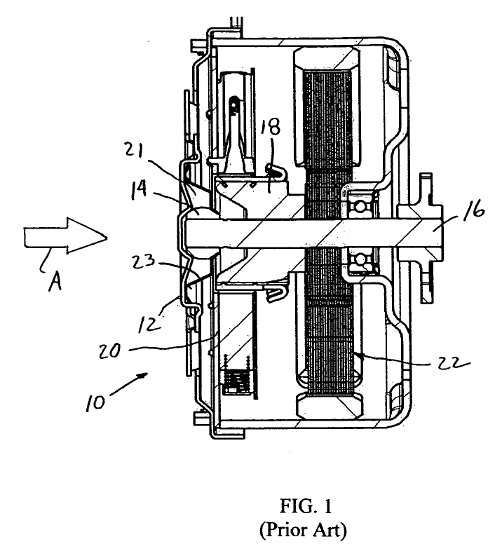

FIG. 2 is a sectional view of the motor of FIG. 1 having a conventional metallic heat shield for protecting the motor from radiant heat.

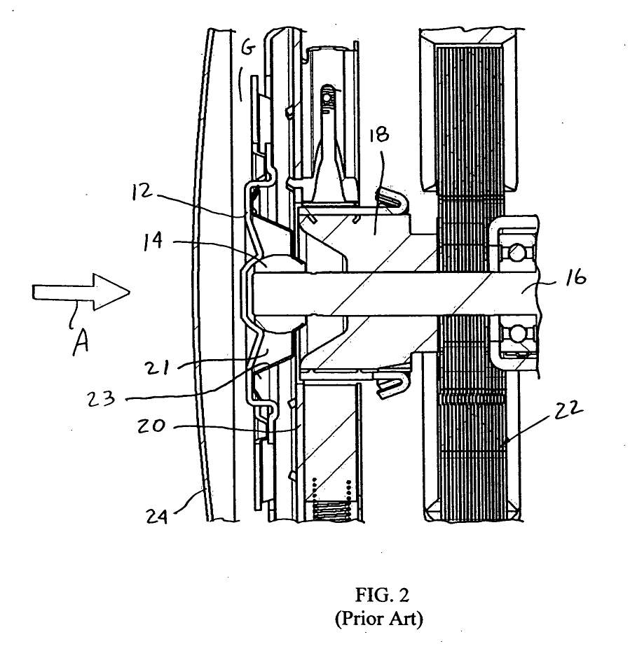

FIG. 3 is a sectional view of a motor having a constrained layer endcap provided in accordance with the principles of the present invention.

### DETAILED DESCRIPTION OF THE EXEMPLARY EMBODIMENT

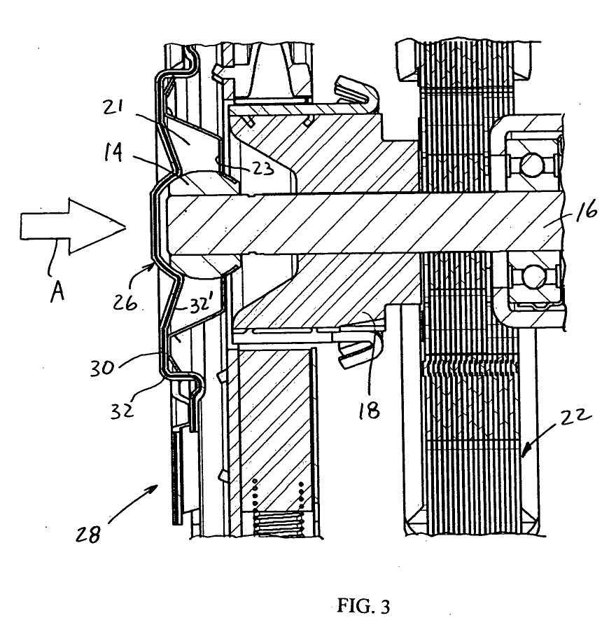

With reference to FIG. 3 and in accordance with the principles of the invention, a constrained layer endcap, generally indicated at 26, is provided for a motor 28, generally indicated at 28. The motor 28 is preferably a DC brush motor for a vehicle engine cooling module, but can be any type of motor that should be shielded from heat.

In the embodiment, the constrained layer endcap 26 employs laminated composite material that comprises a visco-elastic, mica or metallic material 30 constrained between layers of sheet metal 32, 32′. If metal is used, it should preferably be perforated or porous metal. Thus, the endcap 26 defines a composite metal stamping that combines the functions of an endplate and heat shield into single component for an electric cooling fan motor or other components requiring shielding from heat. As shown in FIG. 3, the endcap 26 covers at least the bushing 14 that supports an end of the shaft 16. ProTec® of Dana Corporation is an example of material that can be employed to define the endcap 26.

The constrained layer of material 30 of the endcap 26 can dampen out vibrations and also prevent the transfer of thermal energy between an inner layer 32′ and an outer layer 32 of material. The higher thermal resistance of the material 30 prevents conduction of heat into internal components of the motor 28. Thus, in the embodiment, a structural member and heat shield are combined into one component; the motor endcap 26.

Several variations or derivatives of the described embodiment are contemplated. Although the description of the embodiment mentions only a 3 layer constrained material, it is possible that a multi-layered material could be used (i.e. greater than 3 layers). Additional constrained layers could be used in combination to achieve noise dampening and heat resistance into the same component.

The interior constrained layer 30 does not have to be visco-elastic if better thermal properties could be attained from an alternate thermal isolating material. Also, the constraining layers preferably have similar rates of thermal expansion. For example, both layers 32, 32′ can be of steel or both layers 32, 32′ can be composed of aluminum or other metal. A steel outer layer 32 is preferable to provide adequate part strength and stiffness.

The endcap 26 is best used in applications where an engine cooling fan module is positioned in close proximity to an exhaust manifold or other source of heat. The fan module should be of a “puller” configuration where the fan is located downstream of the radiator core.

The endcap 26 improves the reliability and extends the operating life of the electric motor 28. If the temperature of the bushing 14 exceeds a critical limit, the lubrication contained within the sintered metal bushing and the reservoir 21 is easily lost and the component will fail prematurely causing poor performance, noise or possibly a locked rotor condition. The constrained layer material 30 will thermally isolate the bushing 14 and internal components from the exterior surface of the endcap 26 which is exposed to the radiant energy (arrow A) emitted from the exhaust manifold. The useful operating life and reliability of the motor 28 is extended due to the lower internal component temperatures of the motor.

A second benefit of the endcap 26 is achieved since the inherent material properties of the constrained layer 30 of endcap 26 can dampen vibration of the rotating members and reduce structural excitations or resonances. This could ultimately produce a motor which operates more quietly or prevents vibration from being transmitted into the vehicle structure.

Although the embodiment is described with reference to an endcap of a motor, the laminated composite material can be applied to other under hood rotating machinery with similar operational requirements such as alternators, electric water pumps, starter motors etc.

Some advantages of the embodiment are as follows:
Reduced system cost (reduced component count)
Reduced noise and vibration
Reduced axial length of module assembly
Lower internal component temperatures when compared to a conventional stamped steel endcap due to higher thermal resistance and improved airflow.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An endcap for a motor, the endcap comprising:
at least a first layer of metal material,
at least a second layer of metal material, and
at least a third layer of thermal isolating material constrained between the first and second layers such that the third layer inhibits the transfer of thermal energy from the first layer to the second layer and from the second layer to the first layer.

2. The endcap of claim 1, wherein the third layer is composed of visco-elastic material, mica or metal.

3. The endcap of claim 1, wherein the first and second layers are composed of steel.

4. The endcap of claim 2, wherein the first and second layers are composed of aluminum.

5. The endcap of claim 1, in combination with a motor, the motor having a shaft and a bushing associated with and end of the shaft, the endcap directly covering at least the bushing.

6. The combination of claim 5, wherein the motor is a DC brush motor.

7. An endcap for a motor, the endcap comprising:
at least a first layer of metal material,
at least a second layer of metal material, and
means of thermal isolating material, between the first and second layers, for inhibiting transfer of thermal energy from the first layer to the second layer and from the second layer to the first layer.

8. The endcap of claim 7, wherein the means for isolating is a layer of visco-elastic material, mica, or metal.

9. The endcap of claim 7, wherein the first and second layers are composed of steel.

10. The endcap of claim 7, wherein the first and second layers are composed of aluminum.

11. The endcap of claim 7, in combination with a motor, the motor having a shaft and a bushing associated with and end of the shaft, the endcap directly covering at least the bushing.

12. The combination of claim 11, wherein the motor is a DC brush motor.

13. A heat shield member for shielding a component in an engine compartment of a vehicle, the member comprising:
at least a first layer of metal material,
at least a second layer of metal material, and
at least a third layer of thermal isolating material constrained between the first and second layers such that the third layer inhibits the transfer of thermal energy and vibration from the first layer to the second layer and from the second layer to the first layer.

14. The member of claim 13, wherein the third layer is composed of visco-elastic material, mica, or metal.

15. The member of claim 13, wherein the first and second layers are composed of steel.

16. The member of claim 13 in combination with the component, the component being a motor and the member being an endcap of the motor.

17. The combination of claim 16, wherein the motor has a shaft and a bushing associated with an end of the shaft, the endcap directly covering at least the bushing.

18. The combination of claim 17, wherein the motor is a DC brush motor.
